(19) United States
(12) Patent Application Publication
(10) Pub. No.: US 2015/0000602 A1
(43) Pub. Date: Jan. 1, 2015

(54) ADAPTER SLEEVE FOR BOTTOM OF FEEDERS

(71) Applicant: Aspects, Inc., Warren, RI (US)

(72) Inventor: Barry D. Colvin, Rehoboth, MA (US)

(21) Appl. No.: 14/314,111

(22) Filed: Jun. 25, 2014

Related U.S. Application Data
(60) Provisional application No. 61/839,559, filed on Jun. 26, 2013.

(51) Int. Cl. A01K 39/01

(52) U.S. Cl. CPC A01K 39/01
USPC 119/51.01

(57) ABSTRACT

An improved bird feeder is disclosed. The bird feeder includes a tubular main body having a top open end and a bottom open end. The tubular main body is made of wire mesh material. An adapter sleeve has a circumferential cuff extending therefrom and having a groove. The adapter sleeve is positioned over the open bottom end of the tubular body portion with the bottom portion of the tubular body portion being positioned within the groove of the cuff of the adapter sleeve and secured thereto. A removable base is releasably coupled to the adapter sleeve.

### CROSS-REFERENCE TO RELATED APPLICATION

This patent document claims priority to earlier filed U.S. Provisional Patent Application No. 61/839,559, filed Jun. 26, 2013, the entire contents of which are incorporated herein by reference.

### BACKGROUND OF THE INVENTION

1. Technical Field

The present patent document relates generally to wire mesh tubular bird feeders and more particularly to an adapter sleeve for the bottom of such feeders permitting a removable base to be used, facilitating cleaning

2. Background of the Related Art

Wire mesh tubular bird feeders, such as U.S. Pat. No. 6,453,843, are popular bird feeders designed for feeding shelled peanuts to woodpeckers, nut hatches, chickadees, and other similar birds. However, these types of feeders suffer from the disadvantage of being difficult to clean because the base is often fastened to the wire mesh with screws, making it difficult to remove, and sometimes even riveted, preventing removal entirely. Removal of the base is desirable in order to properly clean out the feeder.

Accordingly, there is a need for an improved base for a wire mesh tubular bird feeder that is easily removable and preferably tool-less.

### SUMMARY OF THE INVENTION

The present invention solves the problems of the prior art by providing an adapter sleeve for a feeder that include a cuff that fits around the open bottom end of the wire mesh feeder. The cuff is fastened to the wire mesh feeder thereby attaching the adapter sleeve thereto. The adapter sleeve includes an end configured and arranged to removably couple to a base without the use of tools. In a preferred embodiment, the adapter sleeve includes a pair of apertures that align with and couple to spring-biased locking pins on a removable base. The base can easily be decoupled or coupled to the adapter sleeve, and consequently the wire mesh feeder, by deflecting the spring-biased locking pins from (or to) the apertures on the adapter sleeve.

### BRIEF DESCRIPTION OF THE DRAWINGS

These and other features, aspects, and advantages of the present invention will become better understood with reference to the following description, appended claims, and accompanying drawings where:

FIG. 1 shows a perspective view of a wire mesh bird feeder, exhibiting the adapter sleeve and snap-on base;

FIG. 2 shows a close up view of the adapter sleeve attached to a wire mesh feeder, detached from the base;

FIG. 3 shows a perspective view of the adapter sleeve, alone;

FIG. 4 shows an exploded view of the wire mesh feeder, with adapter sleeve thereon, being aligned with the detachable base;

FIG. 5 shows a user depressing the buttons on the detachable base to retract the locking pins so that the apertures on the adapter sleeve may be aligned therewith; and

FIG. 6 shows a close up view of the adapter sleeve coupled with the detachable base.

### DESCRIPTION OF THE PREFERRED EMBODIMENT

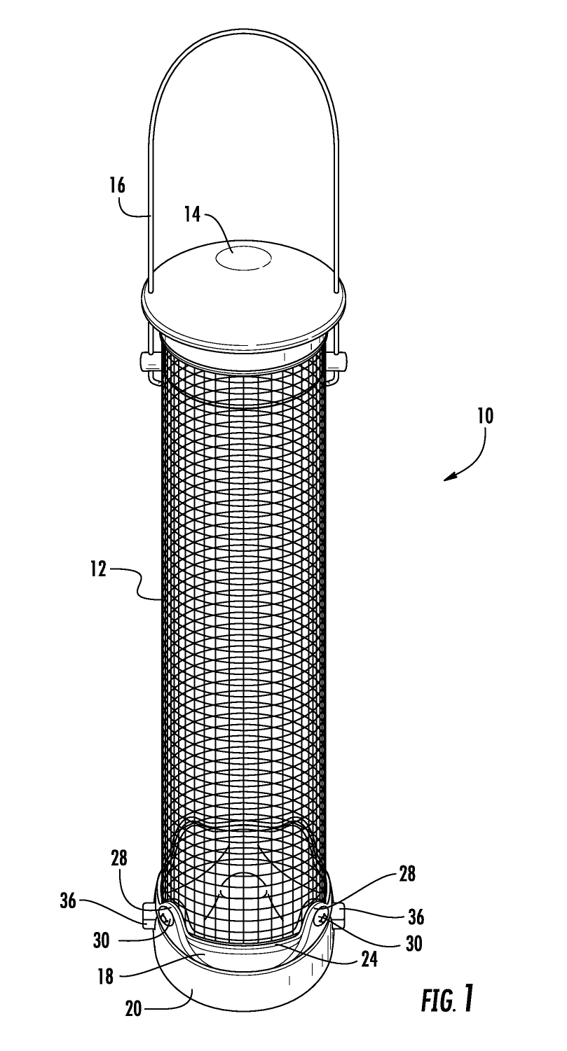

Referring now to FIG. 1, a perspective view of a wire mesh feeder having the adapter sleeve and base thereon are shown generally at 10. Generally speaking, the wire mesh bird feeder 10 includes a tubular body portion 12 made of a wire mesh. The gauge and openings in the wire mesh may be selected as desired in order to retain the desired feed, yet allow birds to peck through the wire mesh at the feeder. The mesh size can also be adjusted to suit the feeder to a particular type of bird that will feed therefrom. The tubular body 12 has an open top end and an open bottom end. The open top end is enclosed by a cap 14 and optionally includes a bail wire 16 to suspend the feeder 10 from a tree, pole or other suspended position. It may also be post-mounted from below (not show). The top cap 14 may be removed or otherwise opened to refill the feeder 10. As will be discussed in more detail below, the adapter sleeve 18 is fastened to the open bottom end of the tubular body 12. The adapter sleeve 18 couples to a removable base 20, via spring-biased locking pins 22 in the base 20.

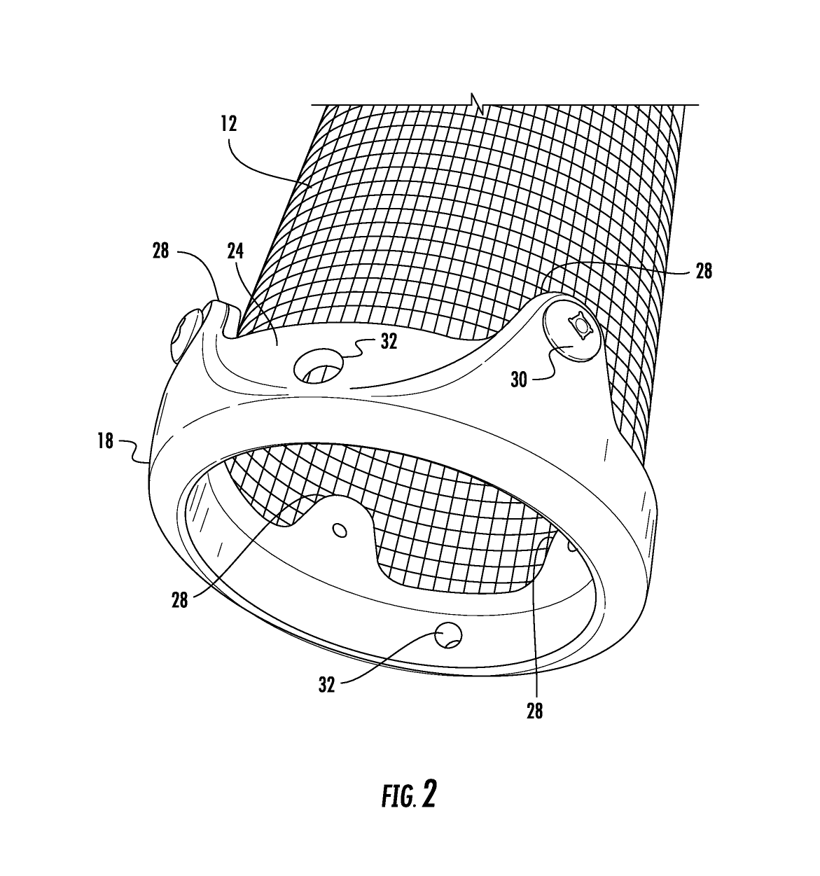

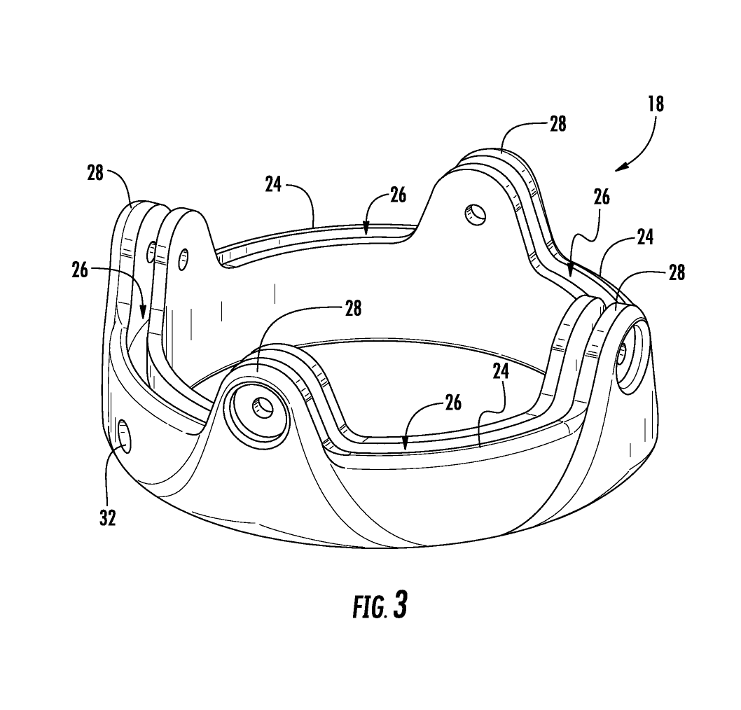

Referring to FIGS. 2 and 3, the adapter sleeve 18 is fastened to the open bottom end of the tubular body portion 12 of the wire mesh feeder 10. The adapter sleeve 18 is generally ring-shaped with an opening to releasably receive the base 20 therethrough. The adapter sleeve 18 includes a cuff 24 with a groove 26 that fits over the open bottom end of the tubular body 12. The cuff 24 is preferably provided with the groove 26 so that the mesh body 12 of the feeder 10 securely sits therein. As a result, the free edges of the mesh, which could be sharp, are also covered to protect the user. The cuff 24 may be of different configurations. For example, the cuff 24 may be of an “L” shape where vertical portion of the L sits on the outer surface of the mesh while the horizontal portion of the L extends inwardly and underneath the bottom edge to cover it and protect it from exposure to the user.

Fastening points 28 extend form the cuff 24 adding further structural support to the adapter sleeve 18. Fasteners 30 are secured through the fastening points 28 and the wire mesh feeder 10. The fasteners 30 could be screws, bolts, rivets or the like. Once fastened on, the adapter sleeve 18 is not intended to be removed from the tubular body portion 12, although it may be possible. The adapter sleeve 18 further includes apertures 32 formed therethrough configured to receive spring-biased locking pins 22 from the removable base 20, therethrough.

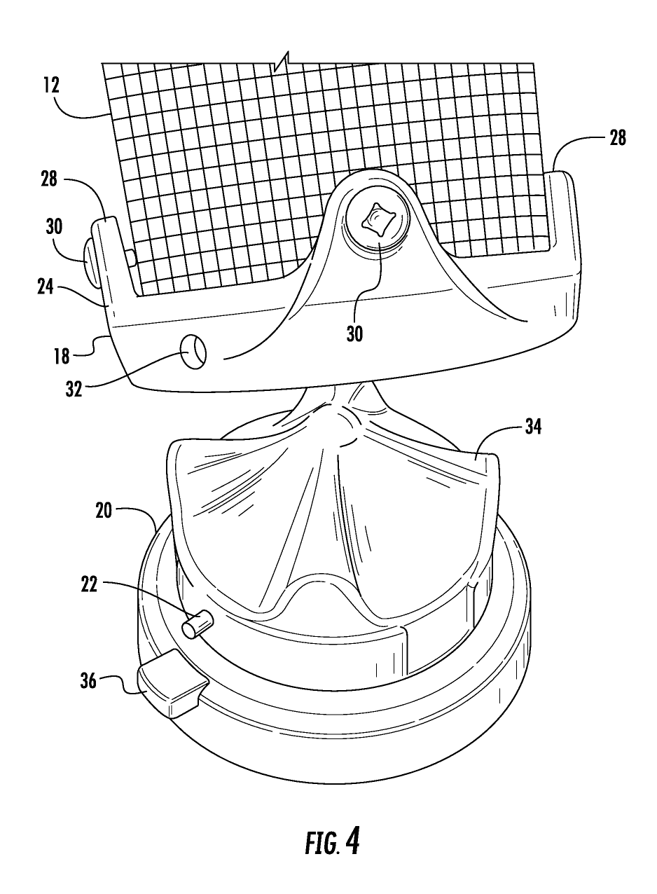

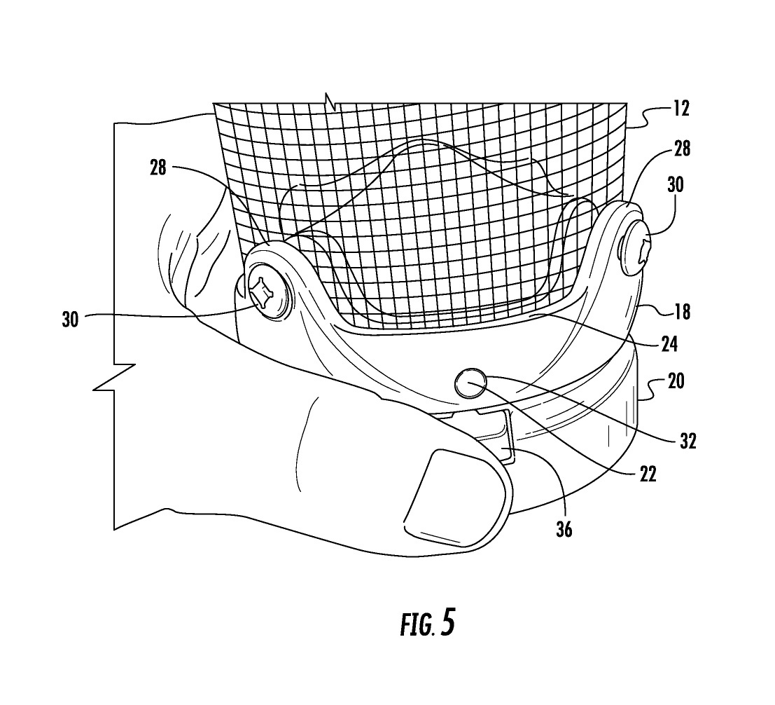

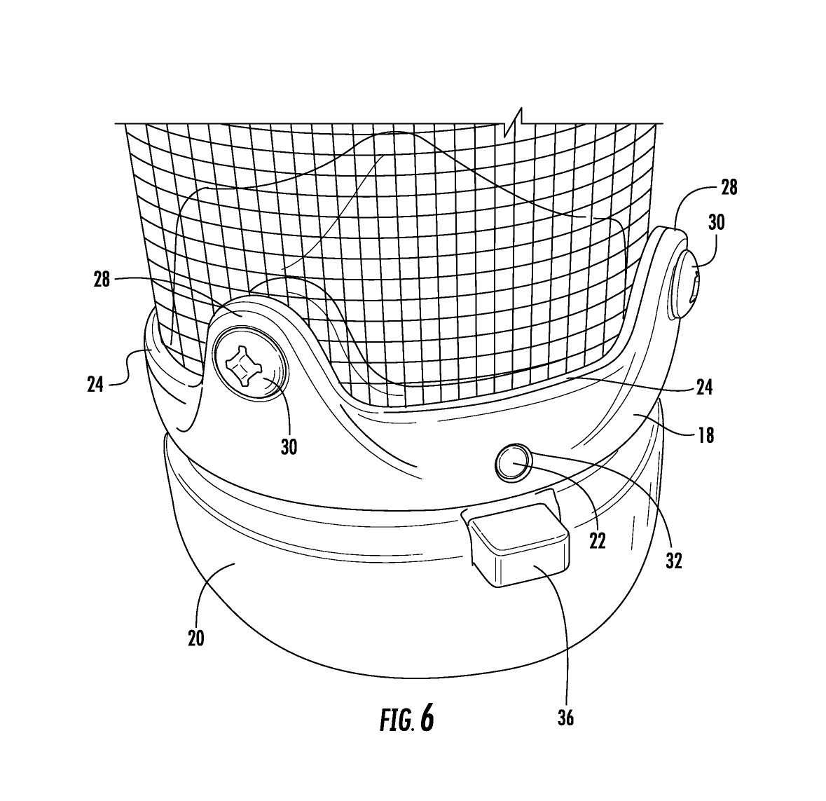

Referring to FIGS. 4-6, the adapter sleeve 18 is fitted over a feed deflector 34 of the removable base 20 and into releasable connection to the removably base 20. The removable base 20 includes a pair of spring-biased locking pins 22 that are retractable into the base 20 by depressing a corresponding set of buttons 36 as generally described in U.S. Pat. No. 7,621,232, incorporated herein by reference. Pushing the buttons 36 drives the locking pins 22 into the base 20 thereby permitting the adapter sleeve 18 to be fully seated on the base 20. The adapter sleeve 18 and wire mesh bird feeder 10 my then be rotationally adjusted to align the apertures 32 with the locking pins 22. Once aligned, the buttons 36 are released, permitting the spring-biased locking pins 22 to engage the apertures 32. Engaged, the locking pins 22 retain the base 20 coupled to the adapter sleeve 18. The buttons 36 are preferably located on opposite sides of the base 20 to permit the user to easily depress the buttons 36.

As can be seen, the adapter sleeve 18 solves the problems of the prior art by uniquely providing an adapter sleeve 18 configured to be affixed to the end of the tubular body portion 12 of a wire mesh feeder 10. This enables a removable base 20 to be removably connected to the bottom of a mesh feeder 10 that, without the adapter 18 of the present invention, would not be able to so accommodate a removably base 20. Therefore, it makes it possible to fit a mesh feeder 10 with a removable base 20. Thus, the adapter sleeve 18 ensures smooth and safe attachment and removal of the base 20 from the body portion 12 of the feeder 10.

The adapter 18 is configured to be selectively locked to a removable base 20, which requires no tools and is easily operated by one hand while the other hand decouples the wire mesh feeder 10 from the base 20. Consequently, the adapter sleeve 18 facilitates cleaning and care of the wire mesh feeder 10 prolonging its useful life and providing more enjoyment to bird watchers.

It would be appreciated by those skilled in the art that various changes and modifications can be made to the illustrated embodiments without departing from the spirit of the present invention. All such modifications and changes are intended to be within the scope of the present invention.

What is claimed is:

1. An improved bird feeder, comprising:
a tubular main body having a top open end and a bottom open end; the tubular main body being made of wire mesh material;
an adapter sleeve having a circumferential cuff extending therefrom and having a groove; the adapter sleeve being positioned over the open bottom end of the tubular body portion with the bottom portion of the tubular body portion being positioned within the groove of the cuff of the adapter sleeve and secured thereto; and
a removable base releasably coupled to the adapter sleeve.

2. The improved bird feeder of claim 1, wherein the removable base is releasably coupled to the adapter sleeve via a pair of spring-biased locking pins received into apertures formed on the adapter sleeve.

3. The improved bird feeder of claim 2, wherein the adapter sleeve has apertures on an inside surface thereof configured and arranged to receive spring-biased locking pins from the removable base.

4. The improved bird feeder of claim 3, wherein the apertures are through-holes.

5. The improved bird feeder of claim 1, wherein the adapter sleeve is ring-shaped with an opening to releasably receive the removable base therethrough.

6. The improved bird feeder of claim 5, wherein the removable base includes a seed deflector extending therefrom that is received through the ring-shaped adapter sleeve and into the tubular body portion.

7. The improved bird feeder of claim 1, wherein the adapter sleeve includes a plurality of fastening points extending from the cuff, configured and arranged for securing the adapter sleeve to the tubular body portion.

8. The improved bird feeder of claim 7, wherein each of the fastening points is fastened to the tubular body portion with a screw.

9. The improved bird feeder of claim 1, wherein said adapter sleeve is secured to said tubular body portion by fasteners.

10. The improved bird feeder of claim 1, further comprising a top cap removably engageable with said open top end of said tubular body portion thereby closing said open top end of said tubular body portion.

11. The improved bird feeder of claim 1, further comprising a bail wire connected to said tubular body portion.

12. The improved bird feeder of claim 1, wherein the cuff extends over a portion of an outside surface of the tubular body portion.

13. The improved bird feeder of claim 12, wherein the cuff extends over a portion of an inside surface of the tubular body portion.

13. The improved bird feeder of claim 1, wherein the cuff extends over a portion of an inside surface of the tubular body portion.

14. The improved bird feeder of claim 13, wherein the cuff extends over a portion of an outside surface of the tubular body portion.
